(19) United States
(12) Patent Application Publication
(10) Pub. No.: US 2013/0088674 A1
(43) Pub. Date: Apr. 11, 2013

(54) LIQUID CRYSTAL DISPLAY

(71) Applicant: HannStar Display Corp., New Taipei City (TW)

(72) Inventors: Chia Hua YU, New Taipei City (TW); I Fang WANG, Changhua (TW); Feng Weei KUO, Pingtung (TW); Ko Ruey JEN, Taipei (TW); Guang Shiung CHAO, Kaohsiung (TW)

(73) Assignee: HANNSTAR DISPLAY CORP., New Taipei City (TW)

(21) Appl. No.: 13/627,276

(22) Filed: Sep. 26, 2012

(30) Foreign Application Priority Data
Oct. 6, 2011 (TW) 100136232

(51) Int. Cl. G02F 1/1337

(52) U.S. Cl. 349/123

(57) ABSTRACT

A liquid crystal display according to the present disclosure is provided. The liquid crystal display of the present disclosure includes an upper substrate, a lower substrate, two data lines, two gate lines, a pixel electrode, a common electrode, a counter electrode, a homeotropic alignment liquid crystal layer, a first alignment film, a second alignment film and a bias electrode. The liquid crystal display with the bias electrode according to the present disclosure may reduce the occurrence of disclination lines.

### CROSS REFERENCE TO RELATED APPLICATION

This application claims the priority benefit of Taiwan Patent Application Serial Number 100136232 filed Oct. 6, 2011, the full disclosure of which is incorporated herein by reference.

### BACKGROUND OF THE INVENTION

1. Field of the Invention

The present invention relates to a liquid crystal display, and more particularly, to a homeotropic alignment liquid crystal display with bias electrodes.

2. Description of the Related Art

The Liquid Crystal Display (LCD) has been broadly used in various applications in the daily life with the improvement and popularity of the digital network technology. Nowadays, the image quality of the LCD is nip and tuck with that of the Cathode Ray Tube (CRT) display. However, there are still some problems for the LCD needed to be improved and solved, such as the small viewing angle, the low contrast ratio, the long responding time, and the non-uniform displaying. Many techniques are developed for obtaining a wider viewing angle of the LCD. Among so many wide viewing angle techniques, the Multi-domain Vertical Alignment (MVA) techniques is one utilizing the properties of the non-identical directions in arrangements and rotations of the liquid crystal molecules to increase the viewing angle and shorten the responding time of the LCD.

The known vertical alignment technique is to align the liquid crystal molecules to be perpendicular to alignment films. Referring to FIG. 1, when the liquid crystal molecules 110 are free of being subjected to a voltage, these molecules 110 are vertically aligned and there is no phase difference between them. Therefore, the liquid crystal layer presents a dark state. Referring to FIG. 2, when the liquid crystal molecules 110 are subjected to a voltage, these molecules 110 are tilted and there is a phase difference between them. Therefore, the liquid crystal layer presents a bright state

However, the fringe field of the pixel electrode 120 may cause disclination lines to occur in the liquid crystal molecules that are located at a side of the pixel. The disclination phenomena not only increase the responding time of the LCD but also cause the LCD to flicker.

Accordingly, there exists a need to provide a solution to solve the aforesaid problems.

### SUMMARY OF THE INVENTION

The present disclosure provides a homeotropic alignment liquid crystal display with bias electrodes that may reduce the occurrence of disclination lines.

In one embodiment, the liquid crystal display of the present disclosure includes an upper substrate, a lower substrate, two data lines, two gate lines, a pixel electrode, a common electrode, a counter electrode, a homeotropic alignment liquid crystal layer, a first alignment film, a second alignment film, and a bias electrode. The data lines and gate lines are positioned on the lower substrate. The pixel electrode and common electrode are positioned on the lower substrate. The counter electrode is positioned on the upper substrate and faces the pixel electrode. The liquid crystal layer includes a plurality of liquid crystal molecules and is sandwiched between the upper and lower substrates. The first alignment film is positioned on the pixel electrode and is configured to align the liquid crystal molecules in a first alignment direction. The second alignment film is positioned on the counter electrode and is configured to align the liquid crystal molecules in a second alignment direction. When the liquid crystal molecules are free of being subjected to a voltage, the liquid crystal molecules are aligned perpendicular to the upper and lower substrates. When the liquid crystal molecules are subjected to a voltage, the liquid crystal molecules are aligned parallel to the upper and lower substrates and are twisted along the first alignment direction and the second alignment direction. The bias electrode is positioned on the lower substrate and at an edge of the pixel electrode, wherein the first alignment direction is toward the bias electrode. The bias electrode is configured to apply a bias voltage to the liquid crystal layer, wherein the bias voltage has a polarity the same as that of a voltage of the pixel electrode.

According to the present disclosure, wherein the bias voltage is greater than a voltage of the pixel electrode.

According to the present disclosure, wherein the bias electrode overlaps with a portion of the pixel electrode.

According to the present disclosure, wherein the bias electrode is positioned parallel to the data lines.

According to the present disclosure, wherein an angle formed between the first alignment direction and the second alignment direction is equal to or smaller than 90 degrees.

According to the present disclosure, wherein the liquid crystal display further includes an inverter configured to invert a polarity of and increase an amplitude of a voltage of the common electrode so as to generate the bias voltage on the bias electrode.

The foregoing, as well as additional objects, features and advantages of the disclosure will be more readily apparent from the following detailed description, which proceeds with reference to the accompanying drawings.

### BRIEF DESCRIPTION OF THE DRAWINGS

FIG. 1 is a schematic view of a conventional liquid crystal display showing the arrangements of liquid crystal molecules in the display when the molecules are free of being subjected to a voltage.

FIG. 2 is a schematic view of a conventional liquid crystal display showing the arrangements of liquid crystal molecules in the display when the molecules are subjected to a voltage.

FIG. 3 is a cross-sectional schematic view of the liquid crystal display according to the present disclosure.

FIG. 4 is a plan schematic view of the array substrate of the liquid crystal display according to the present disclosure.

FIG. 5 is a schematic view of the liquid crystal display according to the present disclosure showing the arrangements of liquid crystal molecules in the display when the bias electrode is activated.

FIG. 6a is an image of pixels in the liquid crystal display of the present disclosure when the bias electrodes are not activated.

FIG. 6b is an image of pixels in the liquid crystal display of the present disclosure when the bias electrodes are activated.

FIG. 7a is an image of pixels in the liquid crystal display of the present disclosure when the bias electrodes are not activated.

FIG. 7b is an image of pixels in the liquid crystal display of the present disclosure when the bias electrodes are activated.

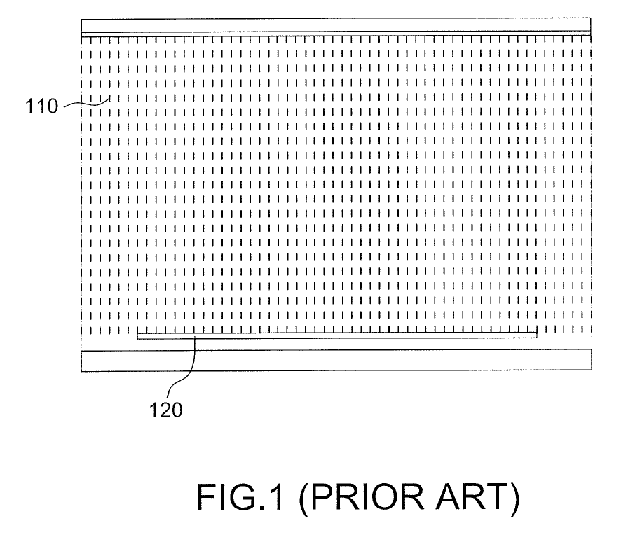

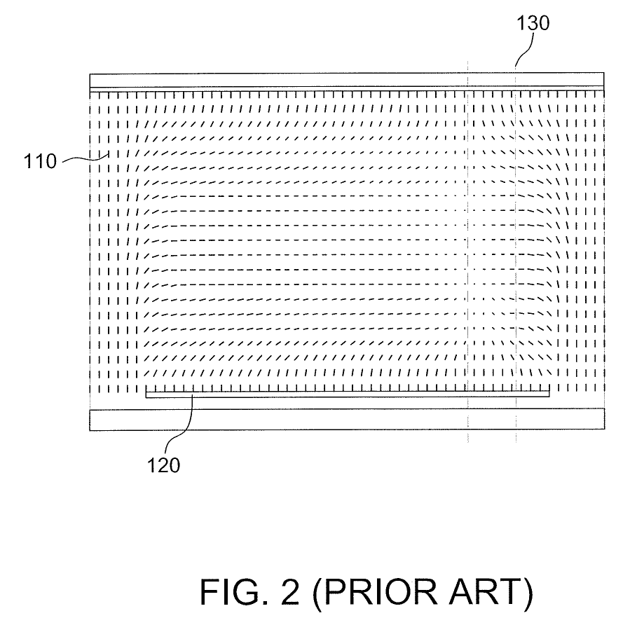

### DETAILED DESCRIPTION OF THE PREFERRED EMBODIMENT

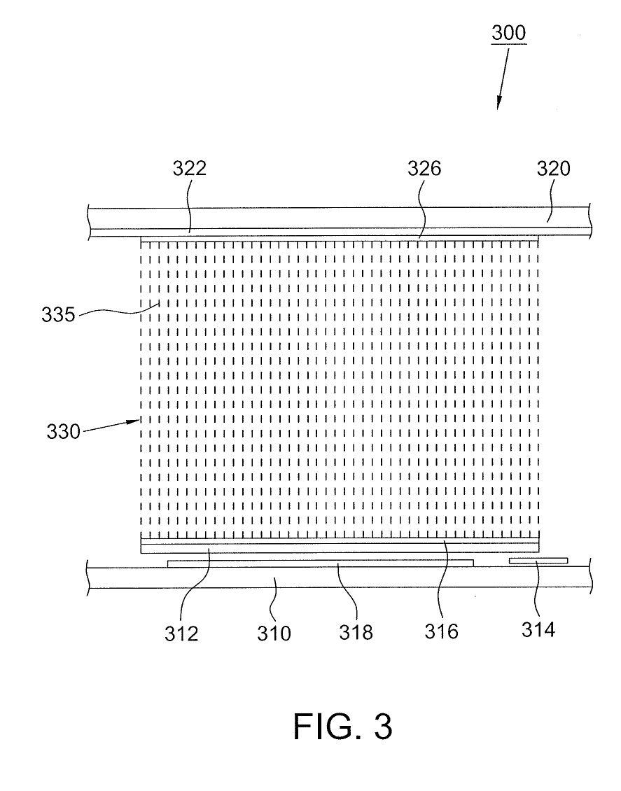

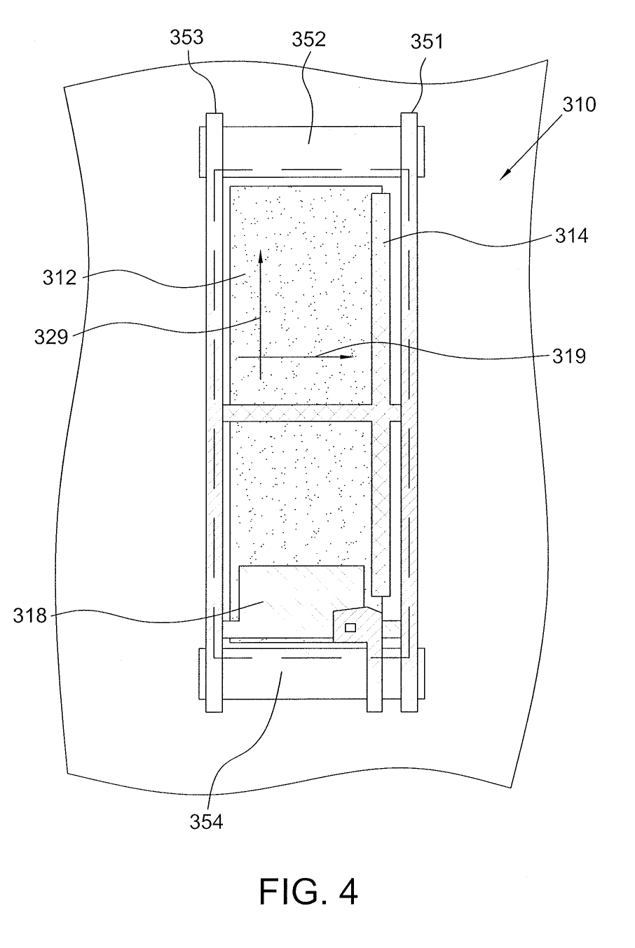

Referring to FIG. 3, the liquid crystal display 300 according to the present disclosure includes a lower substrate 310, an upper substrate 320, and a liquid crystal layer 330 being sandwiched between the lower and upper substrates 310, 320 and having a plurality of liquid crystal molecules 335. In one embodiment, the lower substrate 310 may be an array substrate, the upper substrate 320 may be a color filter substrate, and the liquid crystal layer 330 may be a homeotropic alignment or vertical alignment liquid crystal layer. Referring to FIG. 4, a plurality of longitudinal data lines and a plurality of traverse gate lines are formed on the lower substrate 310, wherein the plurality of the data lines includes at least a data line 351 and a data line 353, and the plurality of the gate lines includes at least a gate line 352 and a gate line 354. A pixel electrode 312 is formed on the lower substrate 310. The pixel electrode 312 is positioned between the data lines 351 and 353, and between the gate lines 352 and 354. In addition, the lower substrate 310 is further provided with a common electrode 318 formed thereon. The common electrode 318 overlaps with a portion of the pixel electrode 312.

Referring to FIG. 3 again, a counter electrode 322 is formed on the upper substrate 320. The counter electrode 322 faces the pixel electrode 312. In addition, an alignment film 316 and an alignment film 326 are formed on the pixel electrode 312 and the counter electrode 322, respectively. The alignment film 316 is formed to align the liquid crystal molecules 335 in a first alignment direction 319, and the alignment film 326 is formed to align the liquid crystal molecules 335 in a second alignment direction 329. Referring to FIGS. 3 and 4 again, a bias electrode 314 is further formed on the lower substrate 310, wherein the first alignment direction 319 is toward the bias electrode 314. An angle between the first alignment direction 319 and the second alignment direction 329 is equal to or smaller than 90 degrees. In one embodiment, the bias electrode 314 is formed longitudinally. The bias electrode 314 is positioned near the data line 351 and on an edge of the pixel electrode 312. The bias electrode 314 overlaps with a portion of the pixel electrode 312.

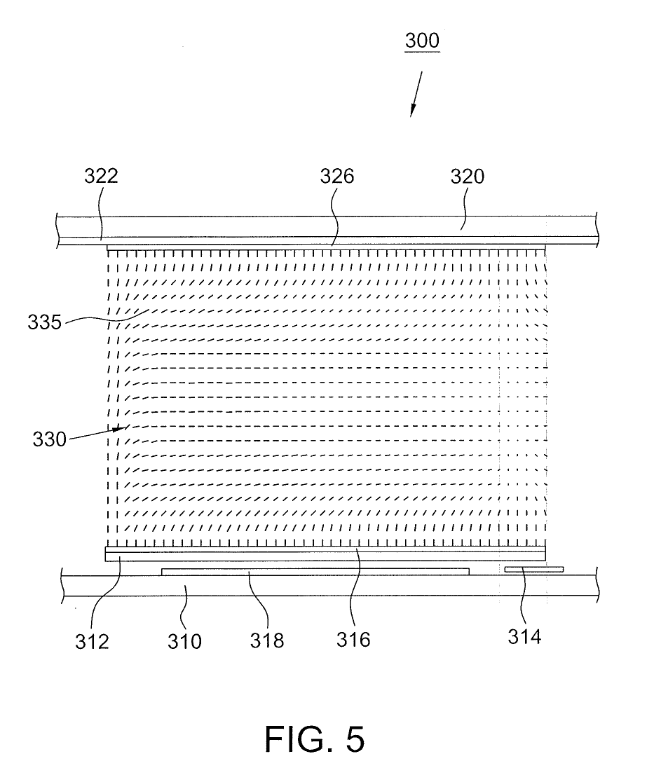

According to the liquid crystal display 300 of the present disclosure, the liquid crystal molecules 335 assume a homeotropic alignment in the absence of an applied field. As shown in FIG. 3, the liquid crystal molecules 335 are aligned perpendicular to the upper and lower substrates 320, 310 at the present state. When the liquid crystal layer 330 is subjected to a large enough voltage, for example, greater than a threshold voltage, the liquid crystal molecules 335 assume a twisted pattern as shown in FIG. 5. At the field-on state the liquid crystal molecules 335 will be twisted along the first alignment direction 319 and the second alignment direction 329 under the alignment film 316 and the alignment film 326. The response of the liquid crystal molecules 335 with subjection to a voltage is much similar to that of the twisted nematic (TN) liquid crystal molecules without subjection to any voltage.

In operation, the bias electrode 314 is used to apply a bias voltage Vbias to the liquid crystal layer 330. The bias voltage Vbias has a polarity the same as that of the voltage Vpixel of the pixel electrode 312 with reference to the voltage Vcom of the common electrode 318. In addition, the bias voltage Vbias is greater than the voltage Vpixel.

Referring to FIG. 5, according to the present disclosure, the introduction of the bias electrode 314 changes the electric field originally built at the edge of the pixel electrode 312 so that disclination lines occur only above the bias electrode 314. Since the light beams passing through the liquid crystal molecules 335 in this area will not arrive at a viewer's eyes, the flicker phenomenon on the liquid crystal display 300 may be reduced accordingly.

According to the present disclosure, an inverter is further provided in the liquid crystal display 300 to invert a polarity and increase an amplitude of the voltage Vcom so as to generate the bias voltage Vbias on the bias electrode 314.

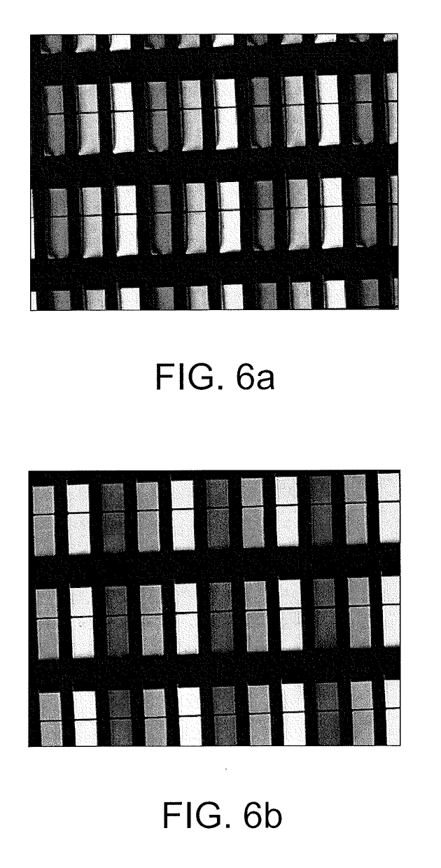

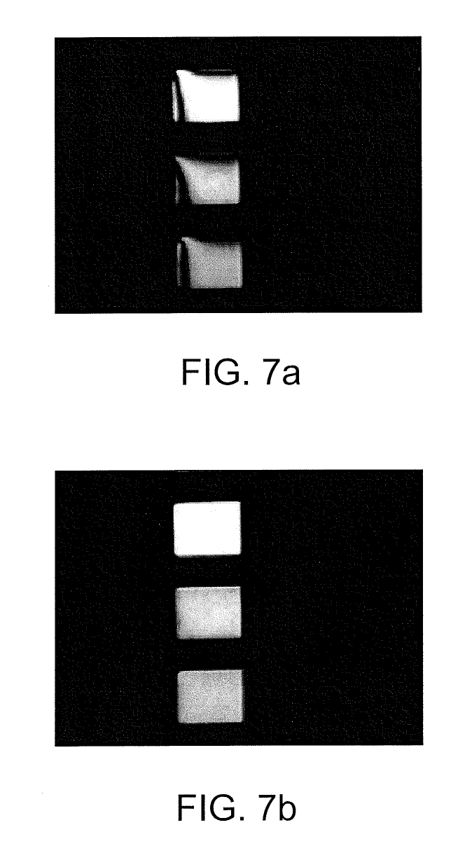

Referring to FIG. 6a, when the bias electrodes located at the left sides of the pixels are not activated, it may be seen that the disclination lines occur at the left sides of the pixels. Referring to FIG. 6b, when the bias electrodes are activated to apply a voltage to the liquid crystal layer, the disclination phenomena are reduced accordingly. Referring further to FIG. 7a, when the bias electrodes located at the left and top sides of the pixels are not activated, it may be seen that the disclination lines occur at both the left and top sides of the pixels. Referring 7b, when the bias electrodes are activated to apply a voltage to the liquid crystal layer, the disclination phenomena are reduced accordingly.

As is seen from FIGS. 6a to 7b, it will be appreciated that the introduction of the bias electrodes may reduce the occurrence of disclination phenomena and therefore improve the display quality.

Although the preferred embodiments of the disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A liquid crystal display, comprising:
an upper substrate;
a lower substrate;
two data lines positioned on the lower substrate;
two gate lines positioned on the lower substrate;
a pixel electrode positioned on the lower substrate;
a common electrode positioned on the lower substrate;
a counter electrode positioned on the upper substrate, the counter electrode facing the pixel electrode;
a homeotropic alignment liquid crystal layer sandwiched between the upper and lower substrates, wherein the liquid crystal layer has a plurality of liquid crystal molecules;
a first alignment film positioned on the pixel electrode to align the liquid crystal molecules in a first alignment direction;
a second alignment film positioned on the counter electrode to align the liquid crystal molecules in a second alignment direction, wherein the liquid crystal molecules are aligned perpendicular to the upper and lower substrates when the liquid crystal molecules are free of being subjected to a voltage, and the liquid crystal molecules are aligned parallel to the upper and lower substrates and are twisted along the first alignment direction and the second alignment direction when the liquid crystal molecules are subjected to a voltage, and
a bias electrode positioned on the lower substrate and at an edge of the pixel electrode, wherein the first alignment direction is toward the bias electrode,
wherein the bias electrode is configured to apply a bias voltage to the liquid crystal layer, and the bias voltage has a polarity the same as that of a voltage of the pixel electrode.

2. The liquid crystal display as claimed in claim 1, wherein the bias voltage is greater than a voltage of the pixel electrode.

3. The liquid crystal display as claimed in claim 1, wherein the bias electrode overlaps with a portion of the pixel electrode.

4. The liquid crystal display as claimed in claim 1, wherein the bias electrode is positioned parallel to the data lines.

5. The liquid crystal display as claimed in claim 1, wherein an angle formed between the first alignment direction and the second alignment direction is equal to or smaller than 90 degrees.

6. The liquid crystal display as claimed in claim 1, further comprising:
an inverter configured to invert a polarity of and increase an amplitude of a voltage of the common electrode so as to generate the bias voltage on the bias electrode.
